(19) United States
(12) Patent Application Publication
(10) Pub. No.: US 2025/0009114 A1
(43) Pub. Date: Jan. 9, 2025

(54) SUPPORT ARTICLE FOR FALL-PROTECTION SAFETY HARNESS

(71) Applicant: 3M INNOVATIVE PROPERTIES COMPANY, St. Paul, MN (US)

(72) Inventors: Matthew P. Thoms, Red Wing, MN (US); Nathan W. Safe, Red Wing, MN (US); Peter R. Blackburn, Carros (FR); Silvia G.B. Guttmann, St. Paul, MN (US); Radovan Simocko, Banska (SK); Eva Mandiková, Prague (CZ)

(21) Appl. No.: 18/691,181

(22) PCT Filed: Sep. 28, 2022
(86) PCT No.: PCT/IB2022/059244

§ 371 Date: Mar. 12, 2024

Related U.S. Application Data
(60) Provisional application No. 63/253,231, filed on Oct. 7, 2021.
(60) Provisional application No. 63/310,210, filed on Feb. 15, 2022.

(51) Int. Cl. A45F 5/02; A62B 35/00

(52) U.S. Cl. CPC A45F 5/021; A62B 35/0025; A45F 2200/0575; A62B 35/0018

(57) ABSTRACT

A support article that is retrofittably attachable to a strap of a fall-protection safety harness. The support article may have a main body, first and second upper struts, first and second lower struts, and a friction ridge. The support article may further comprise at least one connector and wherein at least one item can be connected to the connector so that the support article can support the item.

### BACKGROUND

Safety harnesses are often used to reduce the likelihood of a user experiencing a fall, and/or to safely arrest the user in the event of a fall. Such harnesses are often used in combination with one or more of a self-retracting lifeline (e.g., a personal self-retracting lifeline), an energy-absorbing lanyard, and other fall-protection equipment.

### SUMMARY

In broad summary, herein is disclosed a support article that is retrofittably attachable to a strap of a fall-protection safety harness. The support article may comprise a main body, first and second upper struts, first and second lower struts, a friction ridge, and at least one connector. These and other aspects will be apparent from the detailed description below. In no event, however, should this broad summary be construed to limit the claimable subject matter, whether such subject matter is presented in claims in the application as initially filed or in claims that are amended or otherwise presented in prosecution.

### BRIEF DESCRIPTION OF THE DRAWINGS

FIG. 1 is a view in generic representation of an exemplary fall-protection safety harness equipped with an exemplary support article as disclosed herein.

FIG. 2 is a view of an outward side of an exemplary main body of a support article.

FIG. 3 is a view of an inward side of an exemplary main body of an exemplary support article.

FIG. 4 is a side view of an exemplary main body of an exemplary support article.

FIG. 5 is a perspective view, from generally above and to one side, of an exemplary main body of an exemplary support article.

FIG. 6 is a cross-sectional view of an exemplary main body of an exemplary support article, looking downward along the vertical axis of the main body.

FIG. 7 is a conceptual view of a process of inserting a strap edgewise into an insertion slot of a main body of an exemplary support article, in order to install the support article onto the strap.

FIG. 8 is a view, from an inward side, of an exemplary support article as installed onto a strap, the support article being depicted with an exemplary connector.

FIG. 9 is a cross-sectional view of an exemplary main body of an exemplary support article as installed onto a strap, looking downward along the vertical axis of the main body.

FIG. 10 is a view, from an inward side, of an exemplary support article as installed onto a strap, the support article being depicted with an exemplary connector and with an exemplary closure member that is in an open position.

FIG. 11 is a view, from an inward side, of an exemplary support article as installed onto a strap, the support article being depicted with an exemplary connector and with an exemplary closure member that is in a closed position.

FIG. 12 is a view, from an inward side, of a pair of exemplary support articles as installed onto a strap, the support articles comprising a common connector that is attached to both support articles.

Like reference numbers in the various figures indicate like elements. Some elements may be present in identical or equivalent multiples; in such cases only one or more representative elements may be designated by a reference number but it will be understood that such reference numbers apply to all such identical elements. Unless otherwise indicated, all figures and drawings in this document are not to scale and are chosen for the purpose of illustrating different embodiments of the invention. In particular the dimensions of the various components are depicted in illustrative terms only, and no relationship between the dimensions of the various components should be inferred from the drawings, unless so indicated. Although terms such as “first” and “second” may be used in this disclosure, it should be understood that those terms are used in their relative sense only unless otherwise noted. As used herein as a modifier to a property or attribute, the term “generally”, unless otherwise specifically defined, means that the property or attribute would be readily recognizable by a person of ordinary skill but without requiring a high degree of approximation.

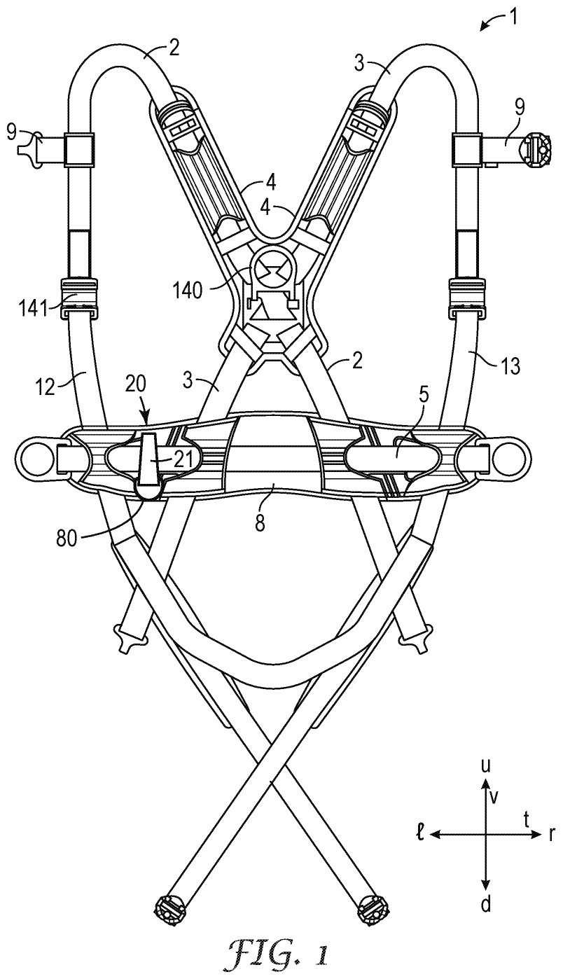

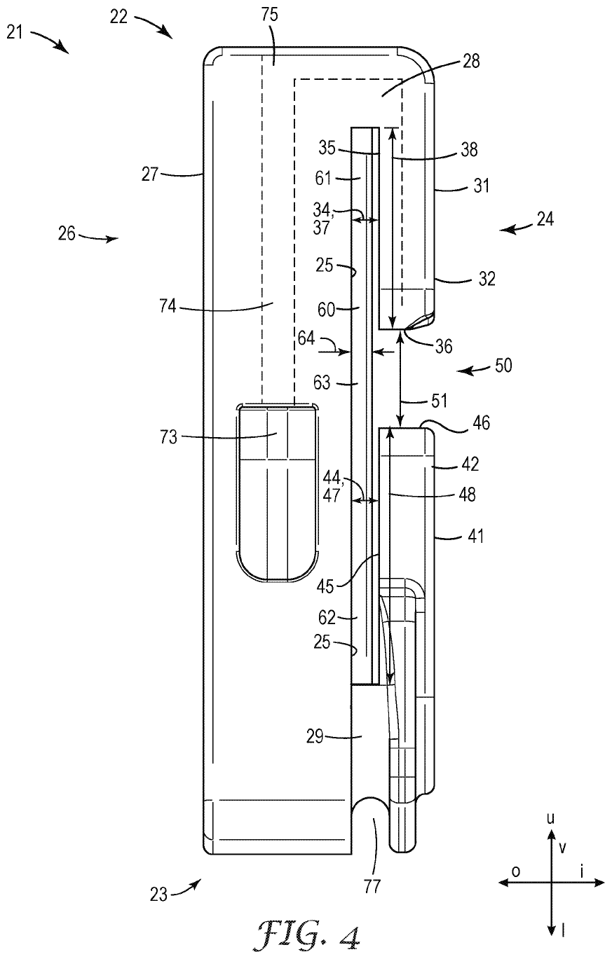

The following terminology is defined with respect to a fall-protection safety harness as worn by a user standing upright, and to a support article as installed on the harness. It is emphasized that this terminology is used for case of description and does not limit the actual orientation of the harness and items installed thereon during actual use. Terms such as vertical, upward and downward, upper, lower, above, and below, and like terminology, correspond to conventional directions with respect to the Earth when the harness is worn by a user who is standing upright. The upward (u) and downward (d) directions along the vertical axis (v) are denoted in FIG. 1 and in various other Figures. The term outward denotes a direction that is generally perpendicular to the vertical axis and is away from the body (e.g. the chest, torso, waist, etc.) of a user of the harness. The term inward denotes a generally opposing direction, toward the body (e.g. the waist) of the user of the harness. Inward and outward directions (i) and (o), and an inward-outward axis defined thereby, are indicated in FIG. 4 and in various other Figures. The term transverse denotes a left-right axis that is generally perpendicular to the vertical and inward-outward directions and is indicated by transverse axis (t) in FIG. 1 and in various other Figures.

It will be appreciated that for a support article installed on a generally horizontally-extending elongate strap of a safety harness (e.g. a waist strap), the transverse axis of the article will be aligned with the long (downweb) axis of the strap and the vertical axis of the article will be aligned with the crossweb “width” of the strap. To avoid confusion, the above terms (e.g. vertical and transverse) will be used when referring to a support article as installed on a strap, and the terms downweb and crossweb will be used herein when characterizing the strap itself.

Unless otherwise specified, descriptive terms and terms of distance and dimension when characterizing a support article are defined as follows. The terms gap and ridge refer to entities characterized by a dimension along the above-defined inward-outward direction; the term height denotes the dimensions of such items along this inward-outward direction. The term length denotes the dimension of items along the above-defined vertical direction. In other words, the term height is reserved for dimensions generally along the inward-outward direction, and the term length is reserved for dimensions generally along the vertical direction. The term width is reserved for dimensions generally along the above-defined transverse direction (excepting the crossweb “width” of a strap as noted above).

### DETAILED DESCRIPTION

Fall-protection safety harnesses, some-times referred to as full-body safety harnesses, are widely used in circumstances in which persons are working at elevation or are otherwise at risk of falling. A fall-protection safety harness is configured to serve in combination with a fall-protection device or apparatus such as, e.g., a self-retracting lifeline or horizontal lifeline, a lanyard or the like, to provide fall protection. In ordinary use, at least one such fall-protection device is typically connected to the safety harness, e.g., to a D-ring or other suitable connection point borne by the harness. Fall-protection safety harnesses will be distinguished from, for example, general-use items such as backpacks and the like.

As illustrated in generic representation in FIG. 1, a fall-protection safety harness 1 will comprise an assembly of various straps that can collectively support the weight of a wearer of the harness in the event of a fall. The particular arrangement of FIG. 1 is intended as an exemplary representation; in actuality a safety harness may vary from the arrangements shown in this Figure. The straps of such a harness are often comprised of flat webbing, made of, e.g., woven synthetic fabric such as, e.g., polyamide, polyaramid (such as, e.g., Kevlar), ultra-high molecular weight polyethylene (such as, e.g., Dyneema) and the like. Such straps are usually flexible so that they can conform to the surface of a wearer's body, can be passed through one or more of buckles, guides, loops and the like, but typically are not significantly extensible. Such straps are interconnected with each other and are often fitted with various pads (e.g., shoulder pads 4 and waist/hip pad 8) to enhance the comfort of the harness, as well as various buckles, latches, connectors, loops, guides, additional pads such as, e.g., chest pads and/or leg pads, and so on. Such components and exemplary arrangements of such components are described in, for example, U.S. Pat. Nos. 8,959,664, 9,174,073, and 10,137,322, all of which are incorporated by reference in their entirety herein.

A safety harness 1 often includes first and second (left and right) shoulder straps 2 and 3 that extend over the top of the shoulders and continue generally downward along the upper portion of the wearer's torso; at such locations they may be referred to herein as chest straps (noting that each chest strap is often an uninterrupted continuation of a shoulder strap, as evident from FIG. 1). In some embodiments, at some point along the wearer's frontal torso, first and second chest straps 2 and 3 may comprise strap adjusters 141 as shown in FIG. 1. Below each strap adjuster, the straps will extend generally downward to meet (and to e.g. interconnect with) a waist strap 5 that encircles at least a portion of the waist/hip area of the user. For convenience of description, straps 12 and 13 that are below strap adjusters 141 may will be referred to as abdominal straps to distinguish them from shoulder/chest straps 2 and 3 that are above strap adjusters 141 (noting that in many cases an abdominal strap may be a continuation of a chest strap).

In some embodiments, harness 1 will also include leg or thigh straps (shown, unnumbered, in FIG. 1); in some embodiments such straps may be a continuation of abdominal straps 12 and 13. In many safety harness designs, first and second shoulder straps 2 and 3, on the rear side of the wearer's torso, will meet, overlap and cross each other at a dorsal crossing point. Often a dorsal D-ring 140 is provided at such a location as shown in FIG. 1. D-rings may also be provided at other locations, as evident in the exemplary design of FIG. 1. A fall-protection safety harness may also include one or more plates (e.g. a dorsal plate) that may be relatively rigid (e.g., made of molded plastic and/or metal) in comparison to other, relatively flexible harness components such as pads and cushions. In some embodiments a harness may include a chest-strap coupler 9 which, as evident from FIG. 1, is a short, generally horizontally-extending strap that can couple left and right chest straps 2 and 3 to each other to stabilize the harness.

It will be recognized that the exemplary harness as depicted in FIG. 1 and described above falls into the general category of safety harnesses that are often referred to as H-style harnesses; in such harnesses, chest straps 2 and 3 each extend down one side of the wearer's torso without straps 2 and 3 meeting (although, as noted above, they may be connected via a chest-strap coupler 9). Another general category of harnesses are so-called crossover harnesses, in which chest straps 2 and 3 meet (e.g. near the breastbone of the wearer) and cross over each other. It will be understood that the herein-disclosed support article can be used with these, or any other, type of fall-protection safety harness.

Disclosed herein is a support article 20 that can be installed on a strap of a fall-protection safety harness. In many embodiments, a support article 20 may be installed on a so-called waist strap 5 that extends generally horizontally (i.e., along a generally transverse direction as defined above) around the waist/hip area of a user as in the exemplary arrangement of FIG. 1. A support article 20 may, in general, comprise a main body 21 and at least one connector 80 as depicted in exemplary manner in FIG. 1, and may be used to support any useful item, e.g. a tool, as discussed in detail herein.

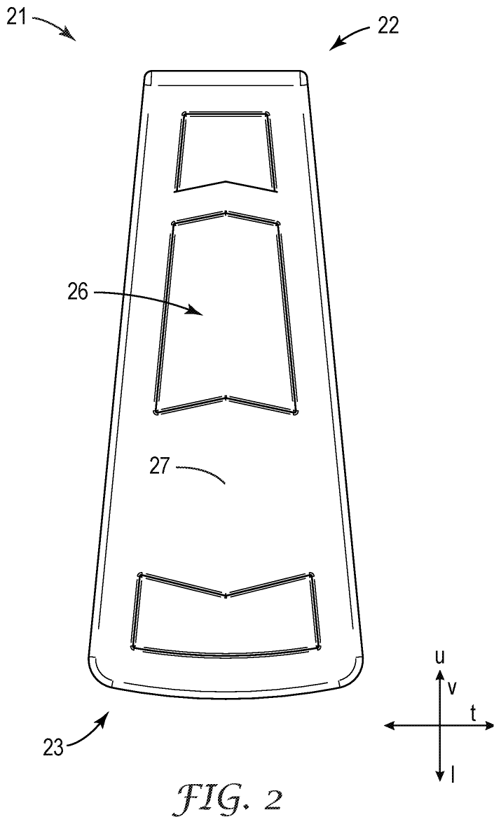

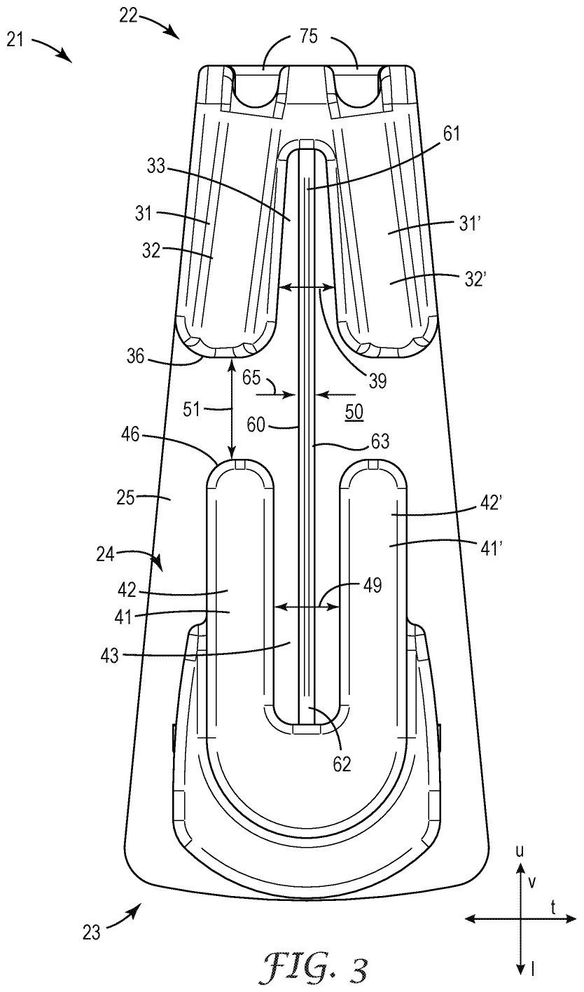

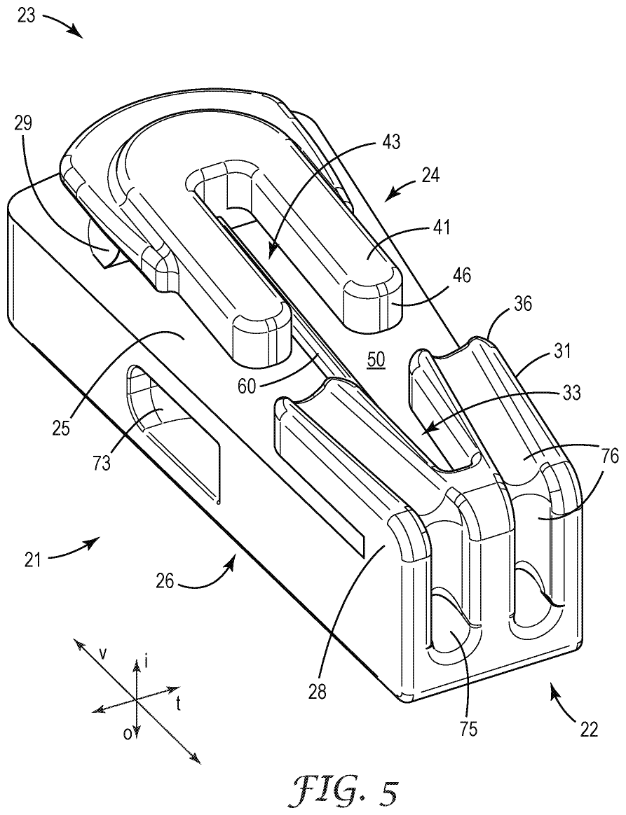

A main body 21 of a support article 20 is depicted in exemplary embodiment in FIGS. 2-5. FIG. 2 is a view of outward side 26 of main body 21; that is, the side that will be visible when the harness, bearing the support article, is worn by a user. As such, the outward major surface 27 of main body 21 may bear identifying indicia, trade designation, decorative markings, and so on. FIG. 3 is a view of inward side 24 of main body 21; that is, the side that will face toward the wearer's body. FIG. 4 is a side view of main body 21; FIG. 5 is a perspective view from generally above and to the side of main body 21. (It is noted that in FIGS. 2-5 and various other Figures herein, a connector 80 is omitted so that various components and features of main body 21 may be easily seen.) As installed on a generally horizontally-extending strap such as a waist strap 5, a support article 20 and main body 21 thereof will comprise an upper end 22 and a lower end 23. As indicated in FIGS. 2-5, support article 20 and main body 21 will comprise a vertical axis (v); in many embodiments, main body 21 may be at least somewhat elongated along vertical axis (v) as evident in FIGS. 2-5. Main body 21 will also comprise an inward-outward axis and an inward side 24 with an inward major surface 25, in addition to the above-mentioned outward side 26 and outward major surface 27. Main body 21 will also comprise a transverse axis (t), also as evident from FIGS. 2-5. In many embodiments, the transverse axis (t) of main body 21 and of support article 20 will be at least generally aligned with a downweb (long) axis of a strap 5 on which support article 20 is installed, as discussed in detail later herein.

In the depicted embodiment and as most easily seen in FIGS. 3 and 5, main body 21 will comprise first and second (e.g. right and left) upper struts 31 and 31′. In many embodiments, these struts may be identical and/or may be mirror images of each other across the vertical axis of main body 21, as evident in FIG. 3. First and second upper struts 31 and 31′ are attached to an upper end of inward side 24 of main body 21, e.g. by way of an upper support buttress 28 that protrudes generally inward from inward side 24 of main body 21. As most easily seen in FIG. 3, each upper strut extends downward generally along the vertical axis of the main body with a lower portion 32 of first upper strut 31 being transversely spaced apart from a lower portion 32′ of second upper strut 31′ to define an upper notch 33 between portions 32 and 32″.

In the depicted embodiment, first and second upper struts 31 and 31′ are slightly diverging; that is, they each are oriented at a slight outward angle relative to the vertical axis of main body 21. Accordingly, in this instance, the terminology of a strut extending “generally” along the vertical axis, encompasses arrangements in which the strut may be angled away from the vertical axis as much as 45 degrees. In various embodiments each upper strut may be angled away from the vertical axis by at most 35, 25, 15, or 5 degrees.

As most easily seen in FIGS. 4 and 5, in the depicted embodiments, the lower portions 32 and 32″ of first and second upper struts 31 and 31′ are each spaced away from the inward major surface 25 of main body 21 along the inward-outward direction. This spacing defines an upper gap 34 between the inward major surface 25 of main body 21 and outward major surfaces 35 of the first and second upper struts 31 and 31′. (It is noted that here and in other Figures and related discussions, primed reference numerals for the “second” strut and various features thereof may not always be shown in Figures or discussed explicitly in the text; however, it will be appreciated that such features as described for one of the struts will typically apply to both.)

Upper gap 34 as described above will be configured to receive an upper section of a strap therein when support article 20 is installed onto the strap, as discussed in detail later herein. Accordingly, upper gap 34 will be configured to have an upper gap height 37 (as indicated in FIG. 4) that is large enough to accommodate the thickness of the strap.

In the depicted embodiment and as most easily seen in FIGS. 3 and 5, main body 21 will comprise first and second (e.g. right and left) lower struts 41 and 41′. In many embodiments, these struts may be identical and/or may be mirror images of each other across the vertical axis of main body 21, as evident in FIG. 3. First and second lower struts 31 and 31′ are attached to a lower end of inward side 24 of main body 21, e.g. by way of a lower support buttress 29 that protrudes generally inward from inward side 24 of main body 21. As most easily seen in FIG. 3, each lower strut extends upward generally along the vertical axis of main body 21 with an upper portion 42 of first lower strut 41 being transversely spaced apart from an upper portion 42′ of second lower strut 41′ to define a lower notch 43 between portions 42 and 42″.

In the depicted embodiment, first and second lower struts 41 and 41′ are oriented substantially parallel to each other rather than at a slight outward angle relative to the vertical axis of main body 21 in the manner of upper struts 31 and 31′. However, in various embodiments, lower struts 41 and 41′ may be outwardly diverging in similar manner to upper struts 31 and 31′; conversely, in some embodiments, upper struts 31 and 31′ may be substantially parallel to each other rather than outwardly diverging. In summary, any such pair of struts may be oriented at any of the above-listed angles relative to the vertical axis of the main body.

As most easily seen in FIGS. 4 and 5, the upper portions 42 and 42′ of first and second lower struts 41 and 41′ are each spaced away from the inward major surface 25 of main body 21 along the inward-outward direction. This spacing defines a lower gap 44 between the inward major surface 25 of main body 21 and outward major surfaces 45 of first and second lower struts 41 and 41′, as most easily seen in FIG. 4. Lower gap 44 will be configured to receive a lower section of a strap therein when support article 20 is installed onto the strap, as discussed in detail later herein. Accordingly, lower gap 44 will be configured to have a lower gap height 47 that is large enough to accommodate the thickness of the strap. In many embodiments, the upper and lower gap heights 37 and 47 may be constant and/or may be very similar or identical to each other, as in the arrangement of FIG. 4.

As seen in FIGS. 3-5, the upper ends 46 of the first and second lower struts and the lower ends 36 of the first and second upper struts collectively define an inwardly-open-ended insertion slot 50 that is between the above-described upper notch 33 and lower notch 43. Insertion slot 50 is configured to allow edgewise insertion of a portion of a strap of a fall-protection harness thereinto during installation of the support article onto the strap as discussed below.

As seen in FIGS. 3-5, main body 21 of support article 20 comprises a friction ridge 60. Friction ridge 60 protrudes generally inwardly from inward major surface 25 of main body 21, and is elongated with a long axis that is at least generally aligned with the vertical axis of the main body, as evident in FIG. 3. An upper portion 61 of friction ridge 60 is positioned transversely between first and second upper struts 31 and 31′ so as to outwardly underlie the above-described upper notch 33; similarly, a lower portion 62 of friction ridge 60 is positioned transversely between first and second lower struts 41 and 41′ so as to outwardly underlie the above-described lower notch 43. An intermediate portion 63 of friction ridge 60 that is between the upper and lower portions 61 and 62 of friction ridge 60, outwardly underlies the above-described insertion slot 50. All of these arrangements are visible e.g. in FIG. 3.

In some embodiments, main body 21, first and second upper struts 31 and 31′, first and second lower struts 41 and 41′, and friction ridge 60, may all be integral portions of a single, unitary, integral unit. In many convenient embodiments such a unit may be made of an injection molded organic polymeric material e.g. with all of the above-listed features being formed concurrently in a single injection-molding operation. In various embodiments, main body 21 (and any integral components thereof) may be made of e.g. nylon 6,6 or any other suitable organic polymeric material.

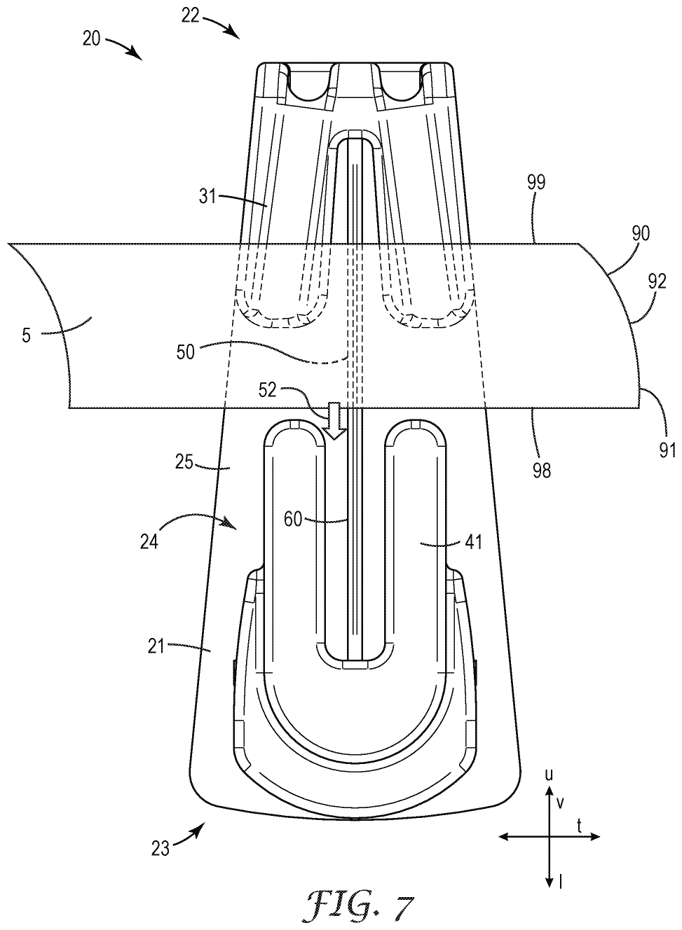

The above-described friction ridge, upper struts, lower struts, the insertion slot between the ends of the upper and lower struts, and the various gaps between the struts and the inward major surface of the main body, are configured to allow a strap to be inserted edgewise into and through the insertion slot so that sections of the strap can enter and reside within the various gaps of the support article main body as the support body is installed onto the strap. This process is illustrated in exemplary, generic representation in FIG. 7, which depicts a support article 20 about to be installed onto an exemplary waist strap 5. As indicated by block arrow 52 in FIG. 7, a user may manipulate strap 5 so that a leading edge 98 of strap 5 is inserted edgewise into insertion slot 50. Leading edge 98 will impinge on friction ridge 60 (and may also impinge on adjacent areas of inward major surface 25 of main body 21) and will be deflected generally downward so as to enter the above-described lower gap 44. This may be continued until leading edge 98 reaches the lower terminus of lower gap 44 (e.g. contacts buttress 29 that supports the lower struts). A lower section 91 of strap 5 will now reside within lower gap 44.

The user may then manipulate strap 5 so that an intermediate section 92 of strap 5 becomes temporarily deformed and deflected inward away from main body 21 (e.g. so that this area of strap 5, when viewed along the downweb axis of strap 5, exhibits a shape somewhat of the form -∧-). This can be continued until trailing edge 99 of strap 5 is in a position that allows it to be inserted into the upper section of insertion slot 50 (i.e., a position just below the lower ends 36 of upper struts 31). The user can then further manipulate strap 5 to urge trailing edge 99 upward so as to enter the above-mentioned upper gap 34 between upper struts 31 and inward major surface 25 of main body 21. The intermediate section 92 can then be pressed outward to undo the temporary deformation, urging trailing edge 99 further upward in the process. This may be continued until trailing edge 99 nears the upper terminus of upper gap 34 (e.g. contacts buttress 28 that supports the upper struts). An upper section 90 of strap 5 will now reside within upper gap 34.

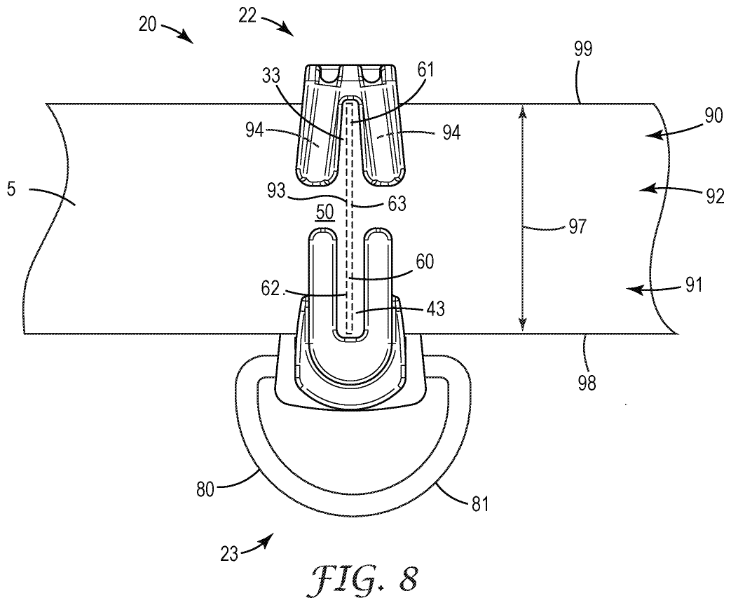

The results of this operation will take the general form shown in FIG. 8. Support article 20 is now installed on strap 5, with lower section 91 of strap 5 residing in lower gap 44, with upper section 90 of strap 5 residing in upper gap 34, and with intermediate section 92 of strap 5 being located outwardly of insertion slot 50. If it is desired to remove support article 20 from strap 5, the above operations can be reversed.

It will be evident e.g. from the side view of FIG. 4 that in the depicted embodiment, lower gap 44 is somewhat longer (along the vertical axis of main body 21) than upper gap 34. This general arrangement, in which one pair of struts (upper pair 31 and 31′, in the depicted case) is configured so that the gap defined by those struts is longer than the gap defined by the other pair of struts (the lower pair of struts, in the depicted case), can make it easier to perform the above-described insertion of the upper and lower sections of the strap into the upper and lower gaps. That is (using the particular example above), if a larger lower section of the strap is initially inserted into the lower gap, the subsequent deforming of an intermediate area of the strap in order to insert an upper section of the strap into the upper gap may be able to be less aggressive (i.e. may necessitate a smaller outward deformation) than would otherwise be needed.

Thus in some embodiments, a lower gap 44 that is defined by upper portions 42 of the first and second lower struts 41 may comprise a lower gap length 48 along the vertical axis of the main body; and, an upper gap 34 that is defined by lower portions 32 of the first and second upper struts 31 may comprise an upper gap length 38 along the vertical axis of the main body, all as visible in FIG. 4. In various embodiments, the lower gap length may be at least 105, 110, 115, or 120% of the upper gap length. In further embodiments, the lower gap length may be at most 150, 145, 140, 135, or 130% of the upper gap length. By way of a specific example, in the exemplary arrangement shown in FIG. 4, the lower gap length 48 appears to be approximately 125% of the upper gap length 38. In embodiments in which it is desired to make the upper gap longer than the lower gap, the above arrangements can be reversed using any of the listed values. Or, in some embodiments the upper and lower gap lengths may be approximately equal, e.g. within plus or minus 5% of each other.

The size (specifically, the length 51, along the vertical axis as illustrated in FIGS. 3 and 4) of the above-described insertion slot 50 can be chosen to enhance the ability to easily insert strap 5 edgewise through insertion slot 50 during installation of the support article onto the strap, and at the same time to provide that the strap, once disposed in the above-described gaps, is unlikely to be caused (e.g. by movement or work activities) to work its way back out of the insertion slot. This insertion slot length 51 may be characterized relative to the above-described upper gap length 38 and lower gap length 48. In various embodiments, insertion slot 50 may exhibit an insertion slot length 51 that is at least 5, 10, or 15% of the additive combination of upper gap length 38 and lower gap length 48. In further embodiments. insertion slot 50 may exhibit an insertion slot length 51 that is at most 40, 35, 30, or 25% of the additive combination of upper gap length 38 and lower gap length 48. By way of a specific example, in the exemplary arrangement shown in FIG. 4, the insertion slot length 51 appears to be approximately 20% of the additive combination of upper gap length 38 and lower gap length 48.

The above-disclosed arrangements allow a support article 20 to be installed onto a strap, e.g. a waist strap 5, of a fall-protection safety harness. In various embodiments, such a support article may be installed at the factory, or in the field by an end user or other designated person. It will be appreciated that the herein-disclosed arrangements do not necessitate that a free end of a strap must be obtained and passed through the support article endwise in order to install the support article on the strap. Those skilled in designing safety harnesses will understand that in many safety harnesses, various straps (e.g. a waist strap) are permanently fixed (e.g. by sewing) to other straps or components of the harness so that a free end of the strap is not available to be passed endwise through a support article. The arrangements disclosed herein allow a support article to be installed on any such strap. Such arrangements thus allow a support article to be retrofitted onto an existing safety harness, by which is meant that the support article can be installed onto a safety harness that has already been manufactured and is at or near its final (e.g. ready-for-use) condition.

In some embodiments, the above-discussed arrangements, features and relationships can be configured to enhance the functioning of the support article in particular ways. For example, in some embodiments, the friction ridge, the first and second upper struts, and the first and second lower struts, may be configured so that support article 20, once installed onto strap 5, exhibits little or no tendency to slidably move along the downweb (long) axis of the strap.

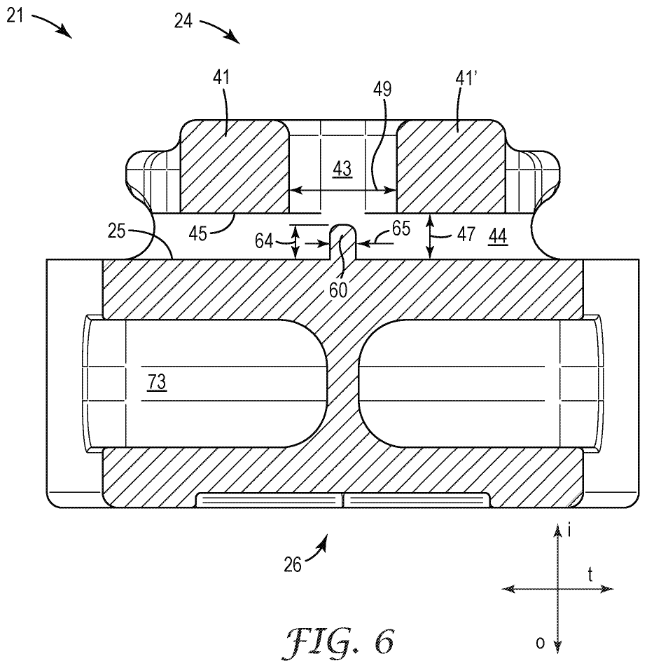

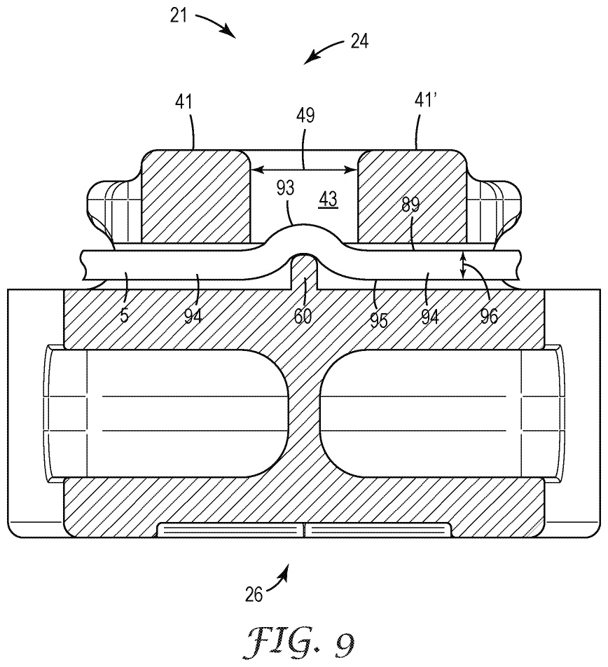

Relationships between various parameters may be controlled for such a purpose, based at least in part on arrangements as depicted in exemplary fashion in FIGS. 6 and 9. FIG. 6 is a cross-sectional view of main body 21, looking along the vertical axis of the main body, so that friction ridge 60 can be seen in cross-sectional view. FIG. 9 is a similar view of main body 21 with strap 5 seated in the various gaps described above. (It is noted that at the position at which the cross-sectional slice of FIGS. 6 and 9 is taken, only lower gap 44 defined by lower struts 41 and 41′ is visible; however, the characterizations herein will apply in similar manner to upper gap 34 as defined by upper struts 31 and 31′.) Portions 94 of strap 5 that reside between outward major surfaces 45 of struts 41 and 41′ will necessarily be coplanar with each other as shown in FIG. 9. However, the presence of friction ridge 60 will cause a portion 93 of strap 5 that inwardly overlies friction ridge 60, to be deformed and deflected slightly inward as shown in exemplary manner in FIG. 9. (Lower notch 43 serves to allow this inward deflection of portion 93.) Portion 93 of strap 5 will thus be forced inwardly out-of-plane in relation to adjacent portions 94 of strap 5. The resulting frictional forces of ridge 60 on major outward surface 95 of strap 5, e.g. in combination with frictional forces of outward major surfaces 45 of lower struts 41 and 41′ on major inward surface 89 of strap 5, and similar frictional forces of outward major surfaces 35 of upper struts 31 and 31′ on major inward surface 89 of strap 5, can be sufficient to generally or substantially prevent any motion of strap 5 in a transverse direction (that is, along the downweb axis of strap 5). This can provide that once support article 20 is installed on a strap 5 of a safety harness, the support article will remain in the installed location and will exhibit little or no tendency to, for example, gradually slide along the long axis of the strap e.g. in response to forces that may occasionally develop on the support article as a result of movements, work activities, etc. It will be appreciated that this can be achieved without the need to manipulate any kind of latch, clamp or the like in a manner that would bring the latch or clamp into direct contact with strap 5 to apply pressure to strap 5 (e.g. to pinch strap 5) to hold the strap in place. Thus in many embodiments, a support article 20 as disclosed herein does not comprise any kind of latch, clamp, clip, or the like, that is configured to be brought into direct contact with a strap to hold the support article in place on the strap.

The arrangements described above are characterized as forcing strap 5 to follow a sinuous path transversely through support article 20, as in the exemplary depiction of FIG. 9. A sinuous path is not as extreme as would be the case e.g. with a serpentine path that would subject strap 5 to large-scale deviations from planarity. Rather, in a sinuous path, the inward displacement of portion 93 of strap 5 by friction ridge 60 will be comparatively small, e.g. such that the outward major surface 95 of portion 93 of strap 5 will not be displaced inwardly beyond the inward major surface 89 of portions 94 of strap 5 that transversely bracket strap portion 93. In other words, in many embodiments strap portion 93 will be displaced inwardly a distance that is approximately on the same order as, or somewhat less than, than the thickness 96 of strap 5 itself. In fact, in many cases, when strap 5 with support article 20 installed thereon is viewed as in FIG. 8, any inward deviation of strap portion 93 may be hardly noticeable.

It will thus be appreciated that the arrangements disclosed herein can allow a support article to be installed (e.g. retrofitted) onto a strap of a safety harness by slidably inserting the strap into gaps provided in the main body of the support article with the slidable movement being edgewise along a crossweb direction of the strap. Once installed, the strap may be substantially unable to move relative to the main body of the support article along a downweb direction (that is, along the long axis) of the strap.

It will also be appreciated that the arrangements disclosed herein can allow a support article 20 to be made with a main body 21 that is quite narrow in the transverse direction. As evident from the exemplary harness depicted in FIG. 1, it is often the case that various harness straps (in particular, a waist strap) may not have much room for installation of an item such as a support article. That is, a considerable portion of the downweb length of the strap may be occupied by various items such as one or more pads, plates, D-rings, strap adjusters, lanyard keepers, and so on, to the point where there is little room to install one or more support articles on the strap. The arrangements disclosed herein allow one or more support articles to be installed on a strap while taking up a minimum of the downweb length of the strap. In various embodiments, a support article 20 as disclosed herein may comprise a main body that exhibits a maximum transverse width of no more than 50, 40, 35, 30, or 25 mm.

Various parameters as disclosed herein, and in particular the relationship between various parameters, may be controlled to promote the above-discussed behavior. A first relationship that may be manipulated for this purpose is the height 64 of friction ridge 60 in relation to the gap height 47 of lower gap 44 (as visible in FIG. 6) and in relation to the gap height 37 of upper gap 34. (Upper gap 34 and its gap height 37 are not visible in FIG. 6 but are indicated in FIG. 4.) In various embodiments, at least at some locations along the elongate length of friction ridge 60, the height 64 of friction ridge 60 may be at least 50, 60, or 50% of the gap height 47 of lower gap 44 and of the gap height 37 of upper gap 34. In further embodiments, at least at some locations along the elongate length of friction ridge 60, the height 64 of friction ridge 60 may be at most 100, 95, 90, or 85% of gap height 47 of lower gap 44 and of gap height 37 of upper gap 34. By way of a specific example, in the exemplary arrangement shown in FIG. 6, the height 64 of friction ridge 60 appears to be approximately 80% of gap height 47 of lower gap 44.

It is noted that these and other conditions discussed herein do not necessarily require that friction ridge 60 must be continuous along its entire elongate length. Rather, friction ridge 60 may be interrupted at one or more locations (in the extreme, the “ridge” may take the form of a series of posts), as long as sufficient frictional forces are present to achieve the effects disclosed herein.

Other parameters may be established to enhance the effects disclosed herein. As noted earlier, upper portions 42 of first and second lower struts 41 may be transversely spaced apart from each other to define a lower notch 43 therebetween, which notch exhibits a lower notch transverse width 49. Similarly, lower portions 32 of first and second upper struts 31 may be transversely spaced apart from each other to define an upper notch 33 therebetween, which notch exhibits an upper notch transverse width 39. Such arrangements are visible in FIG. 3. The presence of these notches allows portion 93 of strap 5 to be displaced inwardly as described above. The transverse width of these notches can affect the transverse distance over which the above-described inward displacement, and return to planarity, of strap 5 will take place (as is readily apparent for lower notch transverse width 49 of lower notch 43 as depicted in FIG. 9). These transverse widths, e.g. in relation to the transverse width 65 of friction ridge 60 as indicated in FIG. 9, may thus affect the frictional forces that are applied to strap 5.

Thus in various embodiments, at least at some location on lower portion 62 of friction ridge 60, the transverse width 65 of friction ridge 60 may be at least 5, 10, 15, or 20% of lower notch transverse width 49; in further embodiments, the transverse width 65 of friction ridge 60 may be at most 50, 40, or 30% of lower notch transverse width 49. Similarly, in various embodiments, at least at some location on upper portion 61 of friction ridge 60, the transverse width 65 of friction ridge 60 may be at least 5, 10, 15, or 20% of upper notch transverse width 39; in further embodiments, the transverse width 65 of friction ridge 60 may be at most 50, 40, or 30% of upper notch transverse width 39. By way of a specific example, in the exemplary arrangement shown in FIG. 6, the transverse width 65 of friction ridge 60 appears to be approximately 25% of lower notch transverse width 49 of lower notch 43. As evident for exemplary upper notch 33 as depicted in FIG. 3, in some embodiments the transverse width of a notch, and thus the above-described ratios, may vary along the vertical direction of the notch.

Other parameters may be adjusted in order to promote various features and properties as disclosed herein. For example, in the exemplary design depicted in FIG. 6, the inward surface of friction ridge 60 (that is, the surface that strap 5 will come into contact with) is depicted as being rounded when viewed along the vertical axis of the support article as in FIG. 6. The degree to which this inward surface of ridge 60 is rounded, in particular the sharpness of the transverse corners of this inward surface, can be chosen to promote the desired aggressiveness with which ridge 60 acts to frictionally prevent strap 5 from moving in a downweb direction. Thus in various embodiments, ridge 60 may have an inward surface that may exhibit a profile that, when viewed as in FIG. 6, may range from being smoothly rounded (e.g. semicircular) to having a flat top and sharp (e.g. approaching 90 degrees) corners. Similarly, the transversely-inward corners (visible, unnumbered, in FIG. 6) of struts 41 and 41′ may be sharp (as in the exemplary design of FIG. 6) or rounded.

It will be appreciated that all such parameters and the relationships between various parameters, can be manipulated to achieve the effects described herein. And, still other parameters may be manipulated to advantage. For example, in some embodiments a lower gap 44, and/or an upper gap 34, may exhibit a gap height that decreases toward the end of the gap. This may have the result that, as the leading edge 98 of strap 5 is urged toward the lower end of lower gap 44, and/or as the trailing edge 99 of strap 5 is urged toward the upper end of upper gap 34, the narrowing of the gap may cause the edge of the strap to become wedged in the narrowing gap. This may further enhance the ability to fix the support article immovably in place on the strap without having to use any kind of latch or clamp.

As mentioned earlier, the straps of a fall-protection safety harness are often comprised of flat webbing, made of, e.g., woven synthetic fabric; such straps are usually flexible but not significantly extensible (elastic). The parameters of any such strap may be chosen so as to perform optimally with the above-described arrangements. For example, in various embodiments a strap onto which a support article is installed may comprise a strap thickness 96 (which, as evident in FIG. 9, is oriented in the inward-outward direction of the support article) that is at least 50, 60, or 70% of the gap height 47 of lower gap 44 and of the gap height 37 of upper gap 34. In further embodiments, the strap may comprise a strap thickness that is less than 95, 90, 85, or 80% of the height of the lower gap and of the upper gap. In various embodiments, a strap 5 onto which a support article 20 is installed may comprise a strap crossweb width 97 (which, as evident in FIG. 8, is oriented in the vertical direction of the support article) that is at least 70, 75, 80, or 85% of an additive combination of the lower gap length 48 of lower gap 44, the upper gap length 38 of upper gap 34, and the insertion slot length 51 of insertion slot 50. In further embodiments, the strap may comprise a strap crossweb width 97 that is less than 99, 95, or 90% of this additive combination.

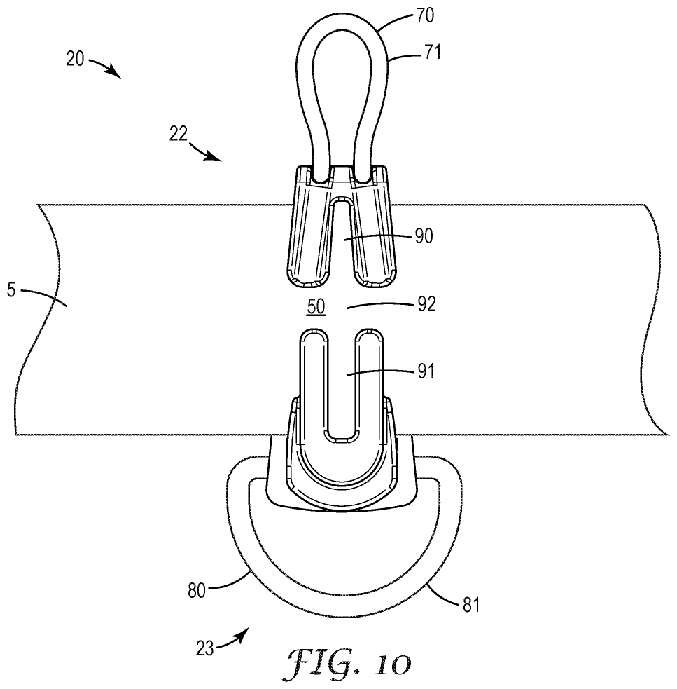

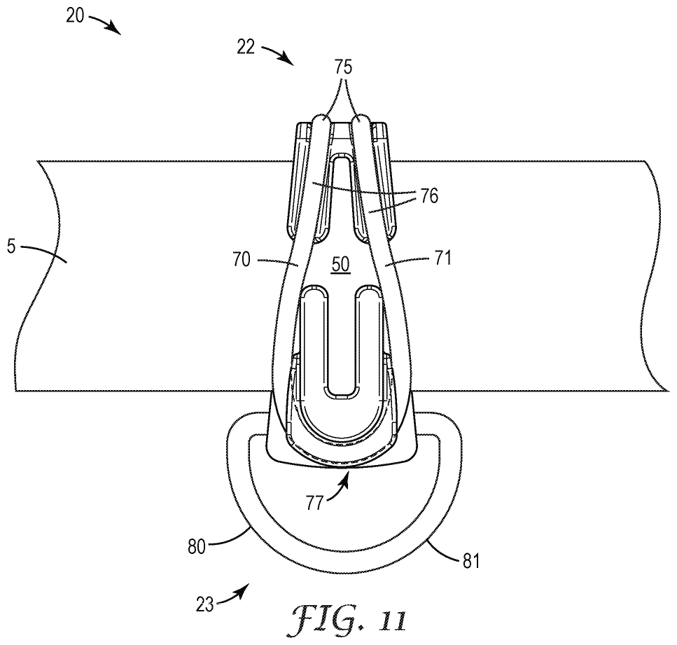

In some embodiments, support article 20 may comprise at least one closure member 70 as depicted in exemplary embodiment in FIGS. 10 and 11. No closure member is shown in FIGS. 1-9 and 12, in order that other items and features may be more easily seen. However, it will be evident that any of the support articles depicted in these Figures may be equipped with a closure member 70. Any such closure member 70 will be configured to remain in an open position (as in FIG. 10) during edgewise insertion of a strap 5 of a fall-protection harness into insertion slot 50 and during the seating of the strap into the previously-described gaps. The closure member 70 will be configured so that after the insertion/seating of the strap of is complete, the closure member can be manually manipulated (e.g. by a person's fingers) from the open position to a closed position (as in FIG. 11) in which the closure member 70 occludes insertion slot 50.

The term “occludes” means that a portion or portions of closure member 70 will physically block or cover the insertion slot 50 to a sufficient extent that strap 5 cannot work its way back out of insertion slot 50 e.g. due to movements, work activities, and the like during ordinary use of the safety harness. It may not be necessary for insertion slot 50 to be fully or completely blocked (although this may occur in some embodiments); rather, slot 50 merely need be blocked or covered to an extent to ensure that strap 5 cannot pass through any remaining area of slot 50 in such manner as might allow strap 5 to exit the main body of the support article.

It will be understood that any such closure member may primarily provide redundancy. That is, the previously-described arrangements can render it unlikely that strap 5 will be able to work loose from the main body of the support article; closure member 70 merely provides an additional level of redundancy in this regard. In many embodiments, strap 5 may not even come into contact with the closure member, or may only come into slight, occasional contact with the closure member, during ordinary use of the harness and support article. It will thus be appreciated that a closure member as defined and described herein is distinguished from a latch or clamp that is closed so as to impinge on a strap (e.g. to press against the strap or pinch the strap) in order to secure the strap within a support article.

The exemplary closure member 70 as depicted in FIGS. 10 and 11 takes the form of an clastic cord 71 that extends from a first vertical end (the upper end 22, in the depicted case) of main body 21 and rejoins the first vertical end of the main body to form a loop that extends from the first vertical end of the main body. When the closure member 70 is in an open position as in FIG. 10, the loop may extend generally away from the main body in any direction, e.g. upward.

After the strap has been inserted within the main body 21 as described earlier herein, the distal end of the loop may be manipulated toward the second vertical end (the lower end 23, in the depicted case of FIG. 11) and disposed in place at the second vertical end. As evident from FIG. 11, this will cause portions of the clastic cord to occlude the insertion slot 50 in the general manner discussed above.

The terminal ends of clastic cord 71 may be connected or attached to the main body 21 in any suitable manner. In the depicted embodiment, cavities 73 are provided on each transverse side of main body 21, as seen e.g. in FIG. 5). During manufacture of the support article, each terminal end of the cord may be passed through an entry/exit 75 (visible in FIGS. 3 and 5) into an interior tunnel 74 (not readily visible in any Figure, but indicated in FIG. 4) so that the terminal end reaches cavity 73. The terminal end may then be treated (e.g. tied into a knot, a rivet or fixture crimped thereto, etc.) so that the terminal end of the cord is too bulky to physically enter tunnel 74, so that the terminal end is held in place in cavity 73. The cord will then extend from cavity 73, through tunnel 74, and will reach exit 75. A similar or identical arrangement can be provided for the other terminal end of the cord.

In the depicted design, grooves 76 are provided in the upper surface of main body 21 to accommodate the cord portions that reside atop the upper end 22 of main body 21. Grooves 76 wrap around to the inward sides of upper struts 31 (as seen most easily in FIG. 5) so that when cord 71 is in the closed position, portions of cord 71 that pass inwardly of the upper portion of the inward side of main body 21 may be seated in these grooves as shown in FIG. 11.

If desired, a seating feature (e.g. a groove 77) can be provided along the lower end of lower struts 41 (such a groove may wrap radially around at least a portion of support buttress 29 that supports lower struts 41), as most easily seen in FIG. 4. The distal end of elastic cord 71 can be seated in this groove 77 when cord 71 is in the closed position, as shown in FIG. 11. Such an arrangement, along with a suitable elasticity of cord 71, can provide that cord 71, once put into its closed position, will be held snugly in place and is unlikely to be dislodged except by purposeful action of a user to re-open the closure member.

It is emphasized that the depicted arrangements are exemplary and that there are numerous ways in which one or more closure members may be provided and arranged to perform the desired function. For example, in some embodiments a closure member might take the form of a cover that is hingedly attached to main body 21 or is slidably attached to main body 21. After installation of the support article onto the strap, the cover may be rotated or slidably moved so that is occludes insertion slot 50 to a sufficient extent. In some embodiments, such a closure member may be a separately made article that is hingedly or slidably attached to main body 21. In other embodiments, such a closure member may be an integral part of main body 21, e.g. a cover that is hingedly connected thereto by way of a living hinge. It will thus be understood that the concept of a closure member broadly encompasses any number of arrangements and configurations. Some such arrangements may rely on the collective action of multiple closure members to act in combination to achieve the desired occlusion of insertion slot 50.

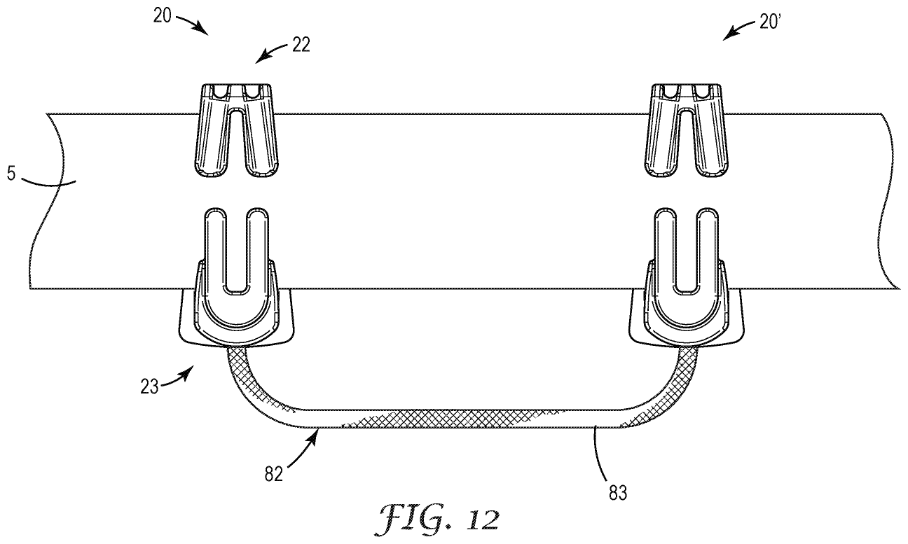

Support article 20 will comprise at least one connector that is attached to main body 21 of article 21 and that can be used to support any desired item. Connectors are omitted from various Figures herein in order to more easily show various features of main body 21; however, exemplary connectors are depicted in FIGS. 1, 8, and 10-11 (connectors 80) and in FIG. 12 (connector 82). A connector may take any suitable form. In the exemplary design of FIGS. 1, 8, and 10-11, a connector 80 is in the form of a D-ring 81 (made of e.g. metal) that generally extends away from lower end 23 of main body 21 of support article 20. In some convenient embodiments, main body 21 can be overmolded onto a base portion of D-ring 81 so that D-ring 81 is attached to main body 21 by way of the base portion of the D-ring being encapsulated within the molded material of a portion of main body 21. In some embodiments, D-ring 81 may be able to rotate relative to main body 21; in other embodiments D-ring 81 may be fixed in position. A D-ring 81 of a support article 20, being configured to withstand forces that arise in the supporting and/or fall-arresting of one or more relatively lightweight tools or the like as discussed below, may be somewhat smaller than e.g. a dorsal D-ring 140 of the type shown in FIG. 1, dorsal D-rings typically being configured to support the full weight of a human user as well as any dynamic forces that develop in the event of a user fall.

A D-ring 81 of the general type described above and depicted e.g. in FIG. 1 is one example of a general class of connector that will be referred to herein as a tool anchorage. By tool anchorage is meant an entity that is permanently attached to main body 21 of article 20 and that can be used to support one or more tools or similar lightweight item(s). The term “tool” anchorage is used broadly, and encompasses any anchorage configured to support not only classical “tools” such as e.g. pliers, wrenches, hammers, screwdrivers, crimping devices, nail guns, stud finders, trowels, and so on, but also that may be configured to support one or more items such as a flashlight, a walkie-talkie (or, in general, any wireless communication device), a tape measure, a pouch, bag or similar holder (e.g. for nails, screws, etc.), and so on. In some embodiments, a tool anchorage will be configured so that any item (or collection of items, if more than one item is supported) that is supported by tool anchorage will weigh no more than five pounds. A support article comprising such a tool anchorage (or, a connector in general) will thus be distinguished from, for example, a component of a fall-protection safety harness that must support the full weight of a human user as well as dynamic forces that develop in the event of a user fall.

As discussed above, in some embodiments a tool anchorage may be provided by an item such as e.g. a D-ring that is made separately from a main body 21 of the support article, and is attached or otherwise permanently joined to the main body to form the anchorage. In other embodiments, a tool anchorage may be incorporated integrally into a main body 21 of a support article. Thus in some embodiments, a main body 21 of support article 20 may take the form of an integral, unitary, molded plastic unit comprised of molded organic polymeric material; in some such cases, the tool anchorage may comprise a member that is molded as an integral part of main body 21 and that defines (at least in part) a through-opening. (Whatever the specific design, a tool anchorage will comprise at least one through-opening whereby a tool can be connected to the anchorage.) In some embodiments, multiple tool anchorages (e.g. one molded-in anchorage, and one D-ring) may be present.

Any such tool anchorage will be configured so that a tool can be temporarily connected to the tool anchorage at least during a time that the tool is actually being used. Thus for example, a tool can be equipped with a tether comprising a connector (e.g. a small carabiner) at the other end of the tether from the tool. The connector can be opened (e.g. a gate of the carabiner can be opened) and a portion of the connector passed through the through-opening of the tool anchorage, after which the connector can be closed so that the tether is secured to the tool anchorage.

Whatever the design, a tool anchorage will be configured so that it can bear the weight of a tool or tools, and so that it can withstand any force that develops if the tool is inadvertently dropped. For example, if a worker is using a tool and accidentally drops it, the tool may fall a distance corresponding to twice the length of the tether (e.g., a distance of up to 2.0 feet, for a 1.0 foot tether). The tool anchorage (and portions of the support article that support the anchorage) will thus be configured so that it can withstand any dynamic forces that develop as a result of the tether arresting the downward motion of the tool, above and beyond forces that result merely from the dead weight of the tool.

Another type of connector 80 is also possible, that can be distinguished from a tool anchorage. Such a connector is exemplified by connector 82 as depicted in FIG. 12. To make use of this type of connector, two support articles 20 and 20′ may be used in combination, e.g. spaced along a downweb extent of a harness strap 5, as in the exemplary arrangement of FIG. 12. The pair of support articles may jointly support a connector 82 that extends between the main bodies of the two support articles. Such a connector 82 is often referred to as a gear loop (sometimes, as an equipment loop); in many embodiments, the gear loop may take the form of an elongate cord (e.g. a length of fabric) 83, with first and second terminal ends of the elongate cord being attached to main bodies of first and second support articles. The attachment may take any suitable form. In some embodiments, e.g. if a fabric is used that can withstand the molding temperature at which the main body is molded, the main body may be overmolded over the terminal end of the fabric to encapsulate and hold the fabric securely. Some such methods may result in permanent attachment of the gear loop to the support article. Other methods (in particular, detachable methods) of attaching terminal ends of an elongate cord to support articles to form a gear loop are described in the above-recited U.S. '608 provisional patent application. Typically, the elongate cord will be relatively inelastic. The elongate cord may be chosen to have a suitable stiffness, and/or a stiffening sheath (e.g. a molded or extruded elongate piece of hollow tubing) may be fitted over fabric of the cord, in order to provide the resulting gear loop with the requisite stiffness.

A gear loop 82 may support the dead weight of one or more tools (e.g., up to a total weight of 5 pounds) in similar manner to an above-described tool anchorage. However, a gear loop may be arranged somewhat differently than a tool anchorage, and in some embodiments may be used to complement the use of a tool anchorage. For example, in some common work practices, one or more tools may be connected to a gear loop 82 (e.g. suspended from the gear loop by means of a tool tether) when the tool is not in active use. When the worker desires to use a particular tool, the worker connect the tether of the tool to the tool anchorage in the general manner described above. (In some embodiments, the tool tether can be connected to the tool anchorage while remaining connected to the gear loop, since the flexible cord that provides the gear loop can be manipulated to allow the connector of the tool tether to be brought to the through-opening of the tool anchorage without necessitating that the connector of the tool tether be disconnected from the cord to do this.) When active use of the tool has ended, the tool may be disconnected from the tool anchorage but remain connected to the gear loop.

The above discussions reveal that in at least some embodiments, a gear loop can be arranged differently from a tool anchorage (e.g. it can be provided by an elongate cord) since in at least some work practices, the gear loop is less likely to be tasked with bearing the full dynamic force that can develop in the event of a tool being dropped. However, in some embodiments, a gear loop may be configured to have any suitable strength, e.g. up to and including the strength needed to withstand dynamic forces that result from a tool drop.

The above discussions above make it clear that in various embodiments, a support article may comprise one or more connectors in the form of a tool anchorage and/or one or more connectors that form part of a gear loop. In some embodiments, a support article may comprise at least one tool anchorage and may also bear a connector that forms part of a gear loop (such arrangements are disclosed in the above-mentioned U.S. '608 provisional patent application). It will be appreciated that an arrangement in which two support articles collectively support a gear loop further leverages the advantages allowed by the herein-disclosed arrangements, which can ensure that, in at least some embodiments, any such support article will be substantially immovable along the downweb axis of the strap. As evident from FIG. 12, if support articles 20 and 20′ are able to slidably move along strap 5, the weight of an item hanging from gear loop 82 may cause support articles 20 and 20′ to gradually slide toward each other. This would decrease the available width of the gear loop along the downweb axis of the strap and thus make it more difficult to, for example, suspend more than one item from the gear loop. Thus in at least some embodiments, support articles as described herein may be substantially immovable along the harness strap on which they are mounted.

In some embodiments, a support article 20 may be used to support one or more tools, e.g. a hammer, screwdriver, pliers, or, in general, any of the tools, items, etc. mentioned above. Various tools that may be supported, and ways in which such tools can be configured so as to be connectable to a support article, are disclosed e.g. in the 3M DBI-Sala Fall Protection Full Line Catalogue (2021/2022). It will be understood that all such disclosures are non-limiting. Moreover, support article 20 is not limited to supporting a tool by way of the tool being e.g. directly attached to a connector of the support article. Rather, again as disclosed in the 3M DBI-Sala Fall Protection Full Line Catalog, in some embodiments a support article can have attached thereto, and support, a holder (e.g. a “holster”) that can itself receive and support a tool or any other suitable item (e.g. a flashlight, a cellular telephone, a tape measure, and so on).

Descriptions and characterizations herein have primarily focused on exemplary embodiments in which a support article 20 is mounted on a generally horizontally (transversely) oriented strap such as a waist strap. It is emphasized that all such descriptions are for purpose of description and do not limit the orientations that the harness, strap, and support article may assume during actual wearing of the harness, the performing of work activities, and so on. Moreover, the herein-disclosed support article is not limited to being installed and used only on a generally transversely oriented strap such as a waist strap. Rather, in some embodiments a support article may be installed e.g. on a strap that extends generally vertically (e.g. a chest strap or abdominal strap) or that extends at some angle intermediate between horizontal and vertical. In such cases, the arrangements and characterizations herein can be straightforwardly applied.

For example, if a support article is installed on a generally vertically-oriented strap such as a chest strap, certain characterizations and descriptions presented herein may be re-oriented 90 degrees. (In other words, the “transverse” and “vertical” characterizations may be swapped; the inward-outward direction will remain the same). It is still further noted that a support article need not necessarily have the various struts and so on disposed on the inward side of the support article. Rather, in some embodiments these items may be disposed on the outward side of the article. In such cases, a straightforward swapping of inward and outward will characterize the resulting arrangements. It is noted in passing that in some embodiments, an inward side of the support article, e.g. of the main body thereof, may be equipped with padding or a cushion for enhanced comfort.

A support article as disclosed herein can be used with any suitable fall-protection safety harness. Such harnesses are well known and may be used with a wide variety of fall-protection apparatus and systems. Fall-protection apparatus and systems (e.g. lanyards, self-retracting lifelines, positioning systems, horizontal systems, vertical systems, and so on), fall-protection anchorages, components of such apparatus, systems, equipment, and so on, as well as numerous types of harnesses, any of which the arrangements disclosed herein may be used with, are described in the 3M DBI-SALA Fall Protection Full Line Catalog (2021/2022). Particular fall-protection apparatus such as self-retracting lifelines and components and functioning thereof are described in various aspects in U.S. Pat. No. 7,843,349, 8,256,574, 8,430,206, 8,430,207, and 9,488,235, all of which are incorporated by reference in their entirety herein.

It is emphasized that a user of any fall-protection safety harness that includes a support article as described herein is tasked with carrying out any appropriate steps, actions, precautions, operating procedures, etc., as required by applicable laws, rules, codes, standards, and/or instructions. That is, under no circumstances will the presence of any arrangement disclosed herein relieve a user of the duty to follow all appropriate laws; rules; codes; standards as promulgated by applicable bodies (e.g., ANSI); instructions as provided by the manufacturer of the fall-protection harness, system, apparatus or components; instructions as provided by the entity in charge of a worksite, and so on.

In summary, all variations and combinations are contemplated as being within the bounds of the conceived invention, not merely those representative designs that were chosen to serve as exemplary illustrations. Thus, the scope of the present invention should not be limited to the specific illustrative structures described herein, but rather extends at least to the structures described by the language of the claims, and the equivalents of those structures. Any of the elements that are positively recited in this specification as alternatives may be explicitly included in the claims or excluded from the claims, in any combination as desired. Any of the elements or combinations of elements that are recited in this specification in open-ended language (e.g., comprise and derivatives thereof), are considered to additionally be recited in closed-ended language (e.g., consist and derivatives thereof) and in partially closed-ended language (e.g., consist essentially, and derivatives thereof). Although various theories and possible mechanisms may have been discussed herein, in no event should such discussions serve to limit the claimable subject matter. To the extent that there is any conflict or discrepancy between this specification as written and the disclosure in any document that is incorporated by reference herein but to which no priority is claimed, this specification as written will control.

What is claimed is:

1. A support article that is retrofittably attachable to a strap of a fall-protection safety harness, the article comprising:
a main body with a vertical axis and an upper end and a lower end, an inward-outward axis and an inward side with an inward major surface and an outward side with an outward major surface, and a transverse axis;
first and second upper struts that are attached to the upper end of the inward side of the main body, each upper strut extending downward generally along the vertical axis of the main body and a lower portion of the first upper strut being transversely spaced apart from a lower portion of the second upper strut to define an upper notch between the lower portions of the first and second upper struts, the lower portions of the first and second upper struts being spaced away from the inward major surface of the main body along the inward-outward direction to define an upper gap between the inward major surface of the main body and outward major surfaces of the first and second upper struts,
first and second lower struts that are attached to the lower end of the inward side of the main body, each lower strut extending upward generally along the vertical axis of the main body and an upper portion of the first lower strut being transversely spaced apart from an upper portion of the second lower strut to define a lower notch between the upper portions of the first and second lower struts, the lower portions of the first and second lower struts being spaced away from the inward major surface of the main body along the inward-outward direction to define a lower gap between the inward major surface of the main body and outward major surfaces of the first and second lower struts,
wherein the upper ends of the first and second lower struts and the lower ends of the first and second upper struts collectively define an inwardly-open-ended insertion slot that is between the upper notch and the lower notch, the insertion slot being configured to allow edgewise insertion of a portion of an elongate strap of a fall-protection harness thereinto during installation of the support article onto the strap;
and,
a friction ridge that protrudes inwardly from the inward major surface of the main body, the friction ridge being elongated with a long axis that is at least substantially aligned with the vertical axis of the main body,
wherein an upper portion of the friction ridge is positioned transversely between the first and second upper struts so as to outwardly underlie the upper notch, a lower portion of the friction ridge is positioned transversely between the first and second lower struts so as to outwardly underlie the lower notch, and an intermediate portion of the friction ridge that is between the upper and lower portions of the friction ridge, outwardly underlies the insertion slot.

2. The support article of claim 1 wherein the friction ridge, the first and second upper struts, and the first and second lower struts, are configured so that the support article, once installed onto an elongate strap of a fall-protection safety harness, is substantially immovable along a downweb direction of the strap.

3. The support article of claim 1 wherein at least at some locations along the elongate length of the friction ridge, a height of the friction ridge is from 50 to 95% of a height of the lower gap and of the upper gap.

4. The support article of claim 1 wherein the upper portions of the first and second lower struts are transversely spaced apart from each other to define a lower notch therebetween exhibiting a lower notch transverse width, wherein the lower portions of the first and second upper struts are transversely spaced apart from each other to define an upper notch therebetween exhibiting an upper notch transverse width; and, wherein at least at some location on a lower portion of the friction ridge, a transverse width of the friction ridge is from 10% to 40% of the lower notch transverse width, and least at some location on an upper portion of the friction ridge, a transverse width of the friction ridge is from 10% to 40% of the upper notch transverse width.

5. The support article of claim 1 wherein the lower gap that is defined by upper portions of the first and second lower struts comprises a lower gap length along the vertical axis of the main body, wherein the upper gap that is defined by lower portions of the first and second upper struts comprises an upper gap length along the vertical axis of the main body, and wherein the lower gap length is from 115% to 135% of the upper gap length.

6. The support article of claim 5 wherein the insertion slot collectively defined by the upper ends of the first and second lower struts and the lower ends of the first and second upper struts, comprises an insertion slot length that is from 15% to 30% of the additive combination of then upper gap length and the lower gap length.

7. The support article of claim 1 wherein the main body, the first and second upper struts, the first and second lower struts, and the friction ridge, are all integral portions of a single, unitary, integral unit that is made of an injection molded organic polymeric material.

8. The support article of claim 1 wherein the support article further comprises at least one closure member that is configured to remain in an open position during edgewise insertion of a portion of a strap of a fall-protection harness through the insertion slot during installation of the support article onto the strap, with the closure member being further configured so that after the edgewise insertion of the portion of the strap of a fall-protection harness through the insertion slot is complete, the closure member can be actuated from the open position to a closed position in which the closure member occludes the insertion slot.

9. The support article of claim 8 wherein the at least one closure member comprises an elastic cord that extends from a first vertical end of the main body and rejoins the first vertical end of the main body to form a loop that extends from the first vertical end of the main body, wherein a second vertical end of the main body that is opposite the first vertical end comprises at least one seating feature that allows a portion of the elastic cord to be seated therein when the elastic cord is in the closed position; and, wherein when the elastic cord is in the closed position, portions of the elastic cord inwardly overlie the insertion slot to occlude the insertion slot.

10. The support article of claim 1 wherein the main body comprises a connector that is a tool anchorage that is permanently attached to the main body of the support article and that allows at least one item to be connected thereto so that the support article can support the item.

11. The support article of claim 10 wherein the tool anchorage is chosen from the group consisting of a D-ring that is permanently attached to the main body of the support article, and a feature that is an integral part of the main body of the support article and that defines at least one through-aperture whereby at least one item can be connected to the tool anchorage so that the support article can support the item.

12. A fall-protection safety harness comprising the support article of claim 1 installed onto a strap of the fall-protection safety harness, wherein with the support article installed onto the strap, an upper section of the strap resides within the upper gap, a lower section of the strap resides within the lower gap; and, an intermediate section of the strap that is between the upper and lower sections of the strap, inwardly overlies the insertion slot.

13. The fall-protection safety harness of claim 12 wherein the friction ridge, the first and second upper struts, and the first and second lower struts, are configured so that the support article, once installed onto the strap, is substantially immovable along a downweb direction of the strap.

14. The fall-protection safety harness of claim 12 wherein with the support article installed onto the strap, the presence of the friction ridge causes the strap to follow a sinuous path transversely through the support article such that a portion of the strap that is inwardly adjacent the friction ridge is displaced inwardly relative to portions of the strap that are outwardly adjacent the first upper strut, the second upper strut, the first lower strut, and the second lower strut.

15. The fall-protection safety harness of claim 12 wherein the strap onto which the support article is installed is a generally-transversely-extending waist strap of the fall-protection safety harness.

16. The fall-protection safety harness of claim 15 wherein the fall-protection harness comprises first and second support articles that are both mounted on the waist strap of the fall-protection safety harness and are spaced apart from each other along the strap, along with an elongate cord comprising first and second opposing ends with the first end of the elongate cord being attached to the main body of the first support article and with the second end of the elongate cord being attached to the main body of the second support article, so that the cord is connected to the first and second support articles to form a gear loop.

17. The fall-protection safety harness of claim 12 wherein the strap onto which the support article is installed comprises a strap thickness that is from 60% to 90% of a height of the lower gap and of the upper gap.

18. The fall-protection safety harness of claim 12 wherein the strap onto which the support article is installed comprises a strap crossweb width that is from about 75% to about 85% of an additive combination of a lower gap length of the lower gap, an upper gap length of the upper gap, and an insertion slot length of the insertion slot.

19. The fall-protection safety harness of claim 12 wherein the support article further comprises at least one closure member that is configured to remain in an open position during edgewise insertion of a portion of a strap of a fall-protection harness through the insertion slot during installation of the support article onto the strap, and wherein with the support article installed onto the strap of the fall-protection safety harness, the at least one closure member is in a closed position in which the closure member occludes the insertion slot.
